(19) United States
(12) Patent Application Publication
(10) Pub. No.: US 2020/0392853 A1
(43) Pub. Date: Dec. 17, 2020

(54) HOT GAS PATH COMPONENT WITH METERING STRUCTURE INCLUDING CONVERGING-DIVERGING PASSAGE PORTIONS

(71) Applicant: General Electric Company, Schenectady, NY (US)

(72) Inventors: Benjamin Paul Lacy, Greer, SC (US); Christopher Donald Porter, Greer, SC (US); Ibrahim Sezer, Greenville, SC (US); James William Vehr, Easley, SC (US)

(21) Appl. No.: 17/004,280

(22) Filed: Aug. 27, 2020

Related U.S. Application Data
(63) Continuation of application No. 15/426,484, filed on Feb. 7, 2017.

(51) Int. Cl. F01D 5/18; F02C 7/18

(52) U.S. Cl. CPC F01D 5/186; F02C 7/18; F05D 2260/202; Y02T 50/60; F05D 2250/232; F05D 2250/324; F05D 2250/323

(57) ABSTRACT

A hot gas path component may include a body, and a passage for delivering a coolant extending through at least a part of the body to an exit area of the body and an end of each passage includes a loop. A metering structure may be in fluid communication with the passage and disposed upstream of the exit area. The metering structure may include a converging passage portion followed by a diverging passage portion.

### CROSS-REFERENCE TO RELATED APPLICATIONS

This application is a continuation of co-pending U.S. patent application Ser. No. 15/426,484, filed 7 Feb. 2017, which is incorporated herein as though fully set forth.

### BACKGROUND OF THE INVENTION

The disclosure relates generally to hot gas path components, and more particularly, to a metering structure including a converging passage portion and a diverging passage portion for use in a coolant passage of a hot gas path component.

Gas turbine systems are one example of turbomachines widely utilized in fields such as power generation. A conventional gas turbine system includes a compressor section, a combustor section, and a turbine section. During operation of a gas turbine system, various components in the system, such as turbine blades and nozzle airfoils, are subjected to high temperature flows, which can cause the components to fail. These components within the hot gas path of the gas turbine system are referred to as hot gas path components and may include, for example, blades, nozzles or parts thereof in the gas turbine, or other parts of the gas turbine. Since higher temperature flows generally result in increased performance, efficiency, and power output of a gas turbine system, it is advantageous to cool the hot gas path components that are subjected to high temperature flows to allow the gas turbine system to operate at increased temperatures.

A hot gas path component, such as a blade, typically contains an intricate maze of internal cooling passages in a body thereof. Coolant provided by, for example, a compressor of a gas turbine system, may be passed through and out of the cooling passages to cool various portions of the blade. Cooling circuits formed by one or more cooling passages in a blade may include, for example, internal near wall cooling circuits, internal central cooling circuits, shroud/tip cooling circuits, and cooling circuits adjacent the leading and trailing edges of the blade. Passages in a hot gas path component may also deliver coolant to an exterior surface of the hot gas path component via an exit area to further cool the body.

### BRIEF DESCRIPTION OF THE INVENTION

A first aspect of the disclosure provides a hot gas path component, comprising: a body; a passage for delivering a coolant, the passage extending through at least a part of the body to an exit area of the body, wherein an end of each passage includes a loop; and a metering structure in fluid communication with the passage and disposed upstream of the exit area, the metering structure including a converging passage portion followed by a diverging passage portion.

A second aspect of the disclosure provides a non-transitory computer readable storage medium storing code representative of at least a portion of a hot gas path component, the at least a portion of the hot gas path component physically generated upon execution of the code by a computerized additive manufacturing system, the code comprising: code representing the at least a portion of the hot gas path component, the at least a portion of the hot gas path component including: a body; a passage for delivering a coolant, the passage extending through at least a part of the body to an exit area of the body, wherein an end of each passage includes a loop; and a metering structure in fluid communication with the passage and disposed upstream of the exit area, the metering structure including a converging passage portion followed by a diverging passage portion.

A third aspect of the disclosure provides a gas turbine system, comprising: a compressor; a combustor operatively coupled to the compressor; and a turbine receiving a hot gas flow from the combustor, the turbine including at least one hot gas path component including: a body; a passage for delivering a coolant, the passage extending through at least a part of the body to an exit area of the body, wherein an end of each passage includes a loop; and a metering structure in fluid communication with the passage and disposed upstream of the exit area, the metering structure including a converging passage portion followed by a diverging passage portion.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of an illustrative turbomachine in the form of a gas turbine system.

FIG. 2 shows a cross-sectional view of an illustrative gas turbine assembly that may be used with the gas turbine system in FIG. 1.

FIG. 3 shows a perspective view of a rotating blade of the type in which embodiments of the present disclosure may be employed.

FIG. 4 shows a perspective view of a turbine vane of the type in which embodiments of the present disclosure may be employed.

FIG. 5 shows a cross-sectional view of a metering structure in a body of a hot gas path component according to embodiments of the disclosure.

FIG. 6 shows a cross-sectional view of another example of a metering structure in a body of a hot gas path component according to embodiments of the disclosure.

FIG. 7 shows an enlarged cross-sectional view of the metering structure from FIG. 6.

FIG. 8 shows a schematic view of another passage arrangement employing a metering structure in a hot gas path component according to embodiments of the disclosure.

FIG. 9 shows a schematic view of another passage arrangement employing a metering structure in a hot gas path component according to embodiments of the disclosure.

FIG. 10 shows a block diagram of an additive manufacturing process including a non-transitory computer readable storage medium storing code representative of a hot gas path component including a metering structure according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant hot gas path components within, for example, a gas turbine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or, for example, the flow of coolant through a passage in the body of a hot gas path component. The term “downstream” corresponds to the direction of flow of the fluid, and the term “upstream” refers to the direction opposite to the flow. It is often required to describe parts that are at differing radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis, such as a rotor axis of a gas turbine. Finally, the term “circumferential” refers to movement or position around an axis. It will be appreciated that such terms may be applied in relation to the center axis of the turbine.

As indicated above, the disclosure provides hot gas path (HGP) component including a passage having a metering structure with a converging passage portion and a diverging passage portion. One challenge of providing coolant and coolant passages in an HGP component is metering or controlling the coolant flow near an exit area thereof, and making the coolant flow reliably. For example, controlling the coolant flow that provides film cooling of the exterior surface of the body of the HGP component is challenging. More specifically, the passages and their respective exit areas are typically formed at a certain size to allow for a certain coolant flow. The final size may be decreased by a number of factors. First, the size of the exit area may be impacted by application of a thermal barrier coating (TBC) to the exterior surface of the body of the HGP component, which may fill a portion of the exit area of the passage. Second, where additive manufacturing is employed, the size of the exit area may contract during cooling of the body or build finishing processes. For example, the exit area may change size due to residual metal powder sintering on the top build surface once the build is complete. Finally, finishing machining may fill part of or plug the exit area of the passage, and require additional machining to remove the offending material. In any event, once the size of the exit area of the passage and/or the size of the passage is selected and manufactured, very little if any changes can be made thereafter to the size of the exit area and/or passage other than to decrease one or both of them. Consequently, if the coolant flow is not as desired after manufacturing, the ability to revise the coolant flow is very limited. A metering structure as described herein addresses many of these challenges.

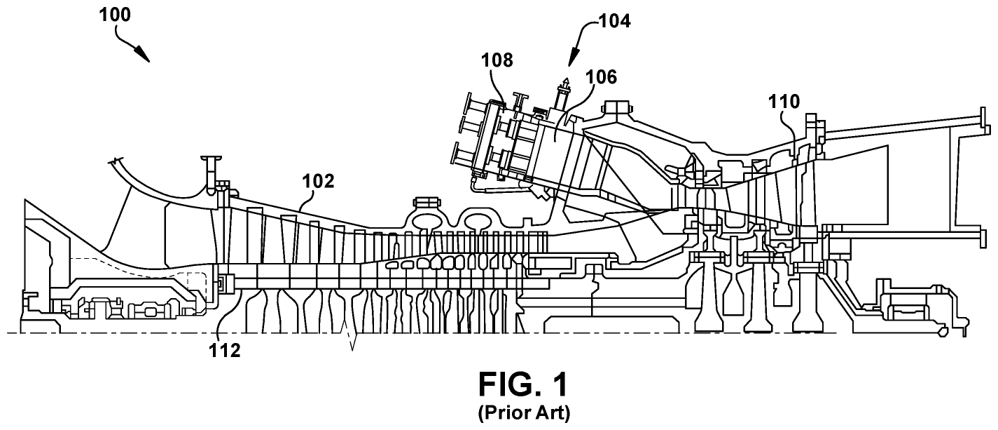

FIG. 1 shows a schematic illustration of an illustrative turbomachine 100 in the form of a combustion or gas turbine system. Turbomachine 100 includes a compressor 102 and a combustor 104. Combustor 104 includes a combustion region 106 and a fuel nozzle assembly 108. Turbomachine 100 also includes a turbine assembly 110 and a common compressor/turbine rotor 112. The present disclosure is not limited to any one particular turbomachine, nor is it limited to any particular combustion turbine system and may be implanted in connection with practically any industrial machine requiring cooling passages. Furthermore, the teachings of the present disclosure are not limited to any particular turbomachine, and may be applicable to, for example, steam turbines, jet engines, compressors, turbofans, etc.

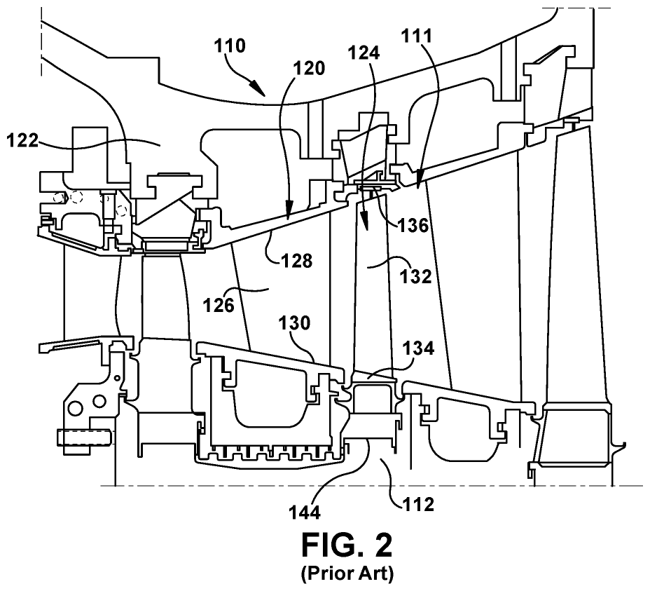

In operation, air flows through compressor 102 and compressed air is supplied to combustor 104. Specifically, the compressed air is supplied to fuel nozzle assembly 108 that is integral to combustor 104. Assembly 108 is in flow communication with combustion region 106. Fuel nozzle assembly 108 is also in flow communication with a fuel source (not shown in FIG. 2) and channels fuel and air to combustion region 106. Combustor 104 ignites and combusts fuel. Combustor 104 is in flow communication with turbine assembly 110 for which gas stream thermal energy is converted to mechanical rotational energy. Turbine assembly 110 includes a turbine 111 that rotatably couples to and drives rotor 112. Compressor 102 also is rotatably coupled to rotor 112. In the illustrative embodiment, there is a plurality of combustors 106 and fuel nozzle assemblies 108.

FIG. 2 shows a cross-sectional view of an illustrative turbine assembly 110 of turbomachine 100 (FIG. 1) that may be used with the gas turbine system in FIG. 1. Turbine 111 of turbine assembly 110 includes a row of nozzle or vanes 120 coupled to a stationary casing 122 of turbomachine 100 and axially adjacent a row of rotating blades 124. A nozzle or vane 126 may be held in turbine assembly 110 by a radially outer platform 128 and a radially inner platform 130. Row of blades 124 in turbine assembly 110 includes rotating blades 132 coupled to rotor 112 and rotating with the rotor. Rotating blades 132 may include a radially inward platform 134 (at root of blade) coupled to rotor 112 and a radially outward tip shroud 136 (at tip of blade). As used herein, the term “hot gas path component” (HGP component) shall refer collectively to stationary vanes 126 and rotating blades 132, unless otherwise stated.

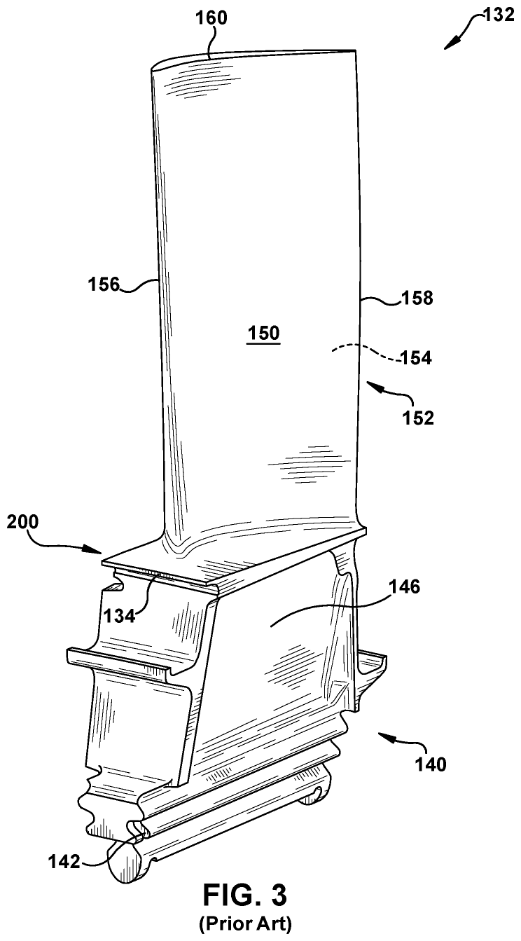

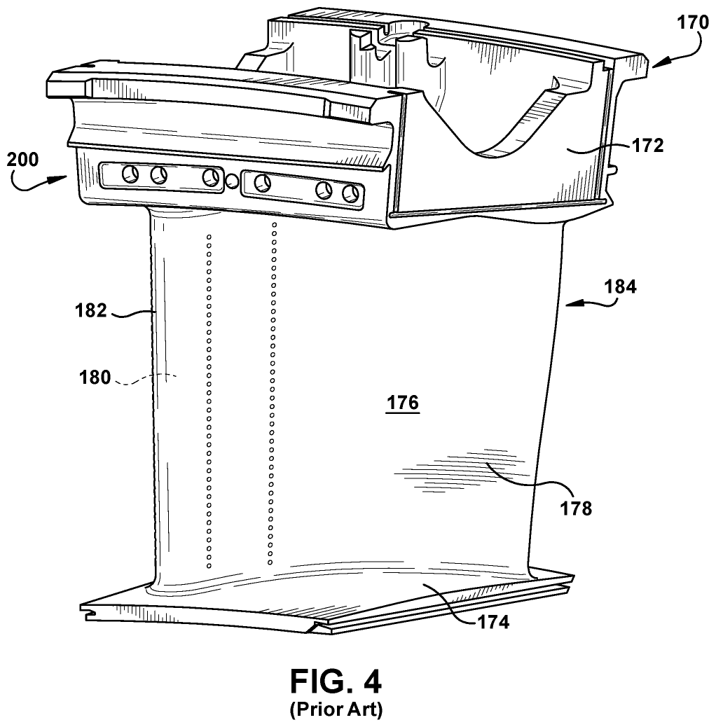

FIGS. 3 and 4 show illustrative hot gas path components of a turbomachine in which teachings of the disclosure may be employed. FIG. 3 shows a perspective view of a rotating blade 132 of the type in which embodiments of the present disclosure may be employed. Turbine rotating blade 132 includes a root 140 by which rotating blade 132 attaches to rotor 112 (FIG. 2). Root 140 may include a dovetail 142 configured for mounting in a corresponding dovetail slot in the perimeter of a rotor wheel 144 (FIG. 2) of rotor 112 (FIG. 2). Root 140 may further include a shank 146 that extends between dovetail 142 and a radially inward platform 134, which is disposed at the junction of airfoil body 150 and root 140 and defines a portion of the inboard boundary of the flow path through turbine assembly 110. It will be appreciated that airfoil body 150 is the active component of rotating blade 132 that intercepts the flow of working fluid and induces the rotor disc to rotate. It will be seen that airfoil body 150 of rotating blade 132 includes a concave pressure side (PS) outer wall 152 and a circumferentially or laterally opposite convex suction side (SS) outer wall 154 extending axially between opposite leading and trailing edges 156, 158 respectively. Sidewalls 152 and 154 also extend in the radial direction from platform 148 to an outboard tip 160.

FIG. 4 shows a perspective view of a stationary vane 170 of the type in which embodiments of the present disclosure may be employed. Stationary vane 170 includes an outer platform 172 by which stationary vane 170 attaches to stationary casing 122 (FIG. 2) of the turbomachine. Outer platform 172 may include any now known or later developed mounting configuration for mounting in a corresponding mount in the casing. Stationary vane 170 may further include an inner platform 174 for positioning between adjacent rotating blades 132 (FIG. 3) platforms 148 (FIG. 3). Platforms 172, 174 define respective portions of the outboard and inboard boundary of the flow path through turbine assembly 110. It will be appreciated that airfoil 176 is the active component of stationary vane 170 that intercepts the flow of working fluid and directs it towards rotating blades 132 (FIG. 3). It will be seen that airfoil 176 of stationary vane 170 includes a concave pressure side (PS) outer wall 178 and a circumferentially or laterally opposite convex suction side (SS) outer wall 180 extending axially between opposite leading and trailing edges 182, 184 respectively. Sidewalls 178 and 180 also extend in the radial direction from platform 172 to platform 174. Embodiments of the disclosure described herein may include aspects applicable to either turbine rotating blade 132 and/or stationary vane 170.

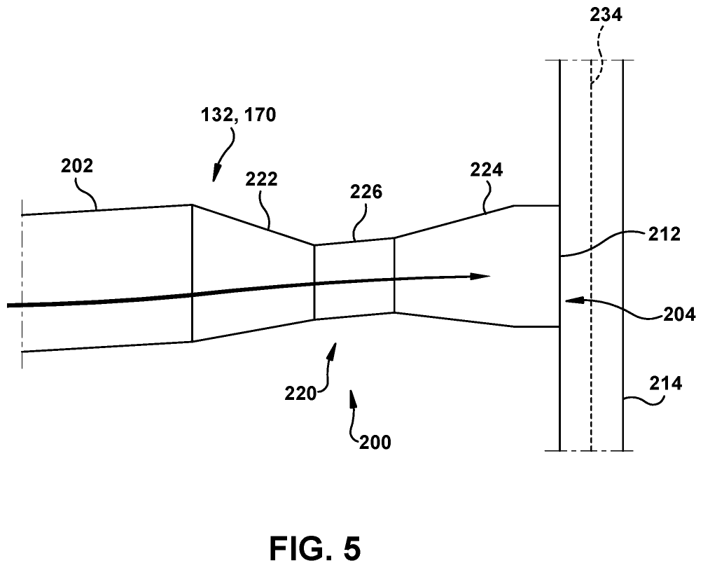

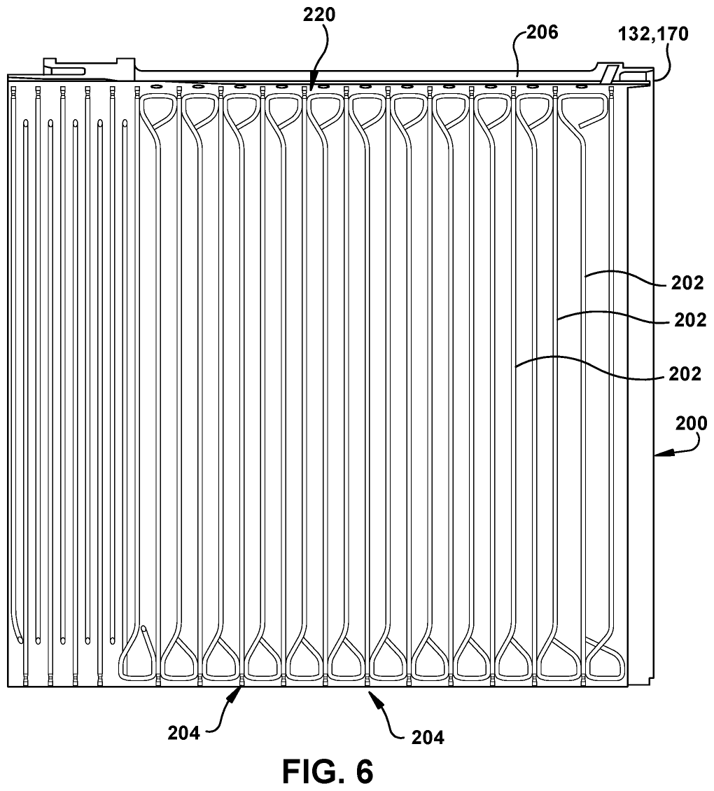

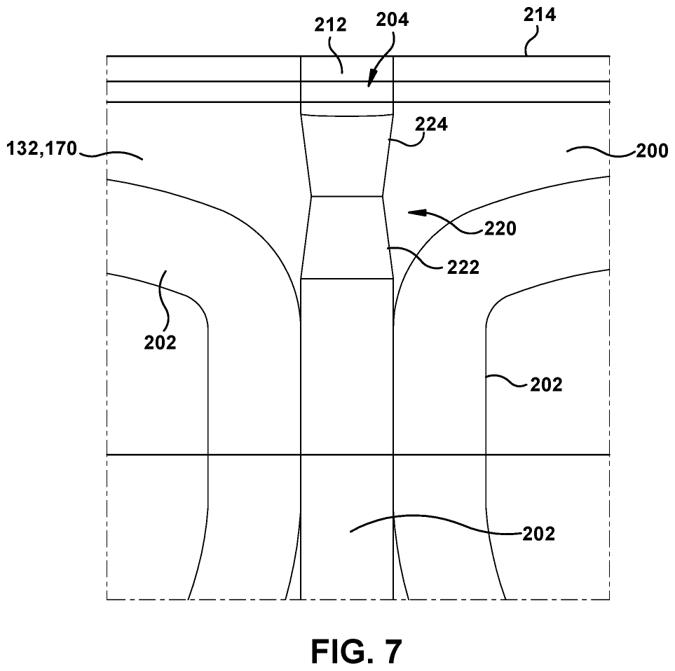

Each hot gas path (HGP) component 132, 170) includes a body 200 that requires cooling. Although certain parts of HGP component 132, 170 are referenced, the “body” may include any portion of either form of HGP component 132, 170 that requires cooling, e.g., airfoil body, platform, root, shroud, etc. FIG. 5 shows a cross-sectional view of a relevant portion of body 200 of an HGP component including a metering structure 220 according to embodiments of the disclosure. HGP component 132, 170 may include a passage 202 for delivering a coolant (arrows) through body 200. As understood in the field, each passage 202 may extend through at least a part of body 200 to an exit area 204 of body 200, and may be at a terminal end of the coolant passage at or near exit area 204. Upstream of exit area 204, passage 202 may take any path desired through body 200 or any other part of HGP component 132, 170. In one embodiment, each passage 202 may have a cross-sectional dimension, e.g., a width or diameter depending on shape, of no greater than 3 millimeters. Such passages are oftentimes referred to as a “microchannel.” Exit area 204 may vary depending on the form of body 200, as will be described herein. FIG. 6, for example, shows a cross-sectional view of a body 200 in the form of a shroud 206, i.e., for use with blade(s) 132, including a number of passages 202 extending in a looped fashion therein in the form of microchannels. Here, as shown in the enlarged view of FIG. 7, exit area 204 includes an opening 212 to an exterior surface 214 of body 200. That is, exit area 204 is in fluid communication with exterior surface 214 of body 200 such that coolant exiting exit area 204 may form a cooling film over exterior surface 214 or purge hot gas from between exterior surfaces.

In contrast to conventional HGP components, HGP components 132, 170 in accordance with embodiments of the disclosure include a metering structure 220 in fluid communication with passage 202 and disposed upstream of exit area 204. Metering structure 220 may include a converging passage portion 222 followed by a diverging passage portion 224. In FIG. 7, converging passage portion 222 meets directly with diverging passage portion 224. In an alternative embodiment, shown in FIG. 5, a coupling passage portion 226 fluidly couples converging passage portion 222 with diverging passage portion 224. In one embodiment, coupling passage portion 226 may include a constant diameter passage portion. In this case, coupling passage portion 226 may have any shape commensurate with passage portions 224, 226 that does not diverge or converge. Passage 202, converging passage portion 222, diverging passage portion 224 and coupling passage portion 226 may have any desired cross-sectional shape, e.g., circular, oval, rectangular, etc, desired for the particular cooling application in which used. In one embodiment, where for example passage 202, a mating diverging passage portion 224 and/or a coupling passage portion 226 is/are circular, converging passage portion 222 may have a frusto-conical shape. The frusto-conical shape may be configured and/or sized to fluidly mate with adjoining fluid carrying structure. Similarly, where for example, exit area 204, a mating converging passage portion 222 and/or a coupling passage portion 226 is/are circular, diverging passage portion 224 may have a frusto-conical shape, which may be configured and/or sized to fluidly mate with adjoining fluid carrying structure.

Metering structure 220 provides a mechanism by which to provide better coolant flow control/metering from exit area 204. In particular, in contrast to conventional exit areas, metering structure 220 provides material that can be further removed to increase coolant flow and/or make the coolant flow more reliable from exit area 204. Metering structure 220 may also allow post-manufacturing coolant flow rate changes by removing or adjusting the shape of the metering structure 220. Modifications can be readily made to metering structure 204 using any now known or later developed technique, e.g., machining such as drilling, chemical reaction such as etching, etc. The resulting, adjustable coolant flow may allow better control of cooling flows through the part and to exterior surfaces to purge or film. As will be described herein, metering structure 220 may be manufactured using additive manufacturing, which allows for precise initial sizing at relatively small dimensions (e.g., microchannel size) and without the need to add material to provide the metering structure, e.g., using an additional layer and drilling, etc. Diverging passage portion 224 allows use of coolant to film or purge on some parts, and will ensure exit area 204, e.g., opening 212, is clear at the top from issues of machining or additive build issues. It will also enable easier finding of exit area 204 after manufacturing. The ability to provide coolant film in this fashion will also allow use of microchannel sized passages on stage 1 nozzles or blades of a gas turbine system 100 (FIG. 1) where film or purge is needed, but not currently provided.

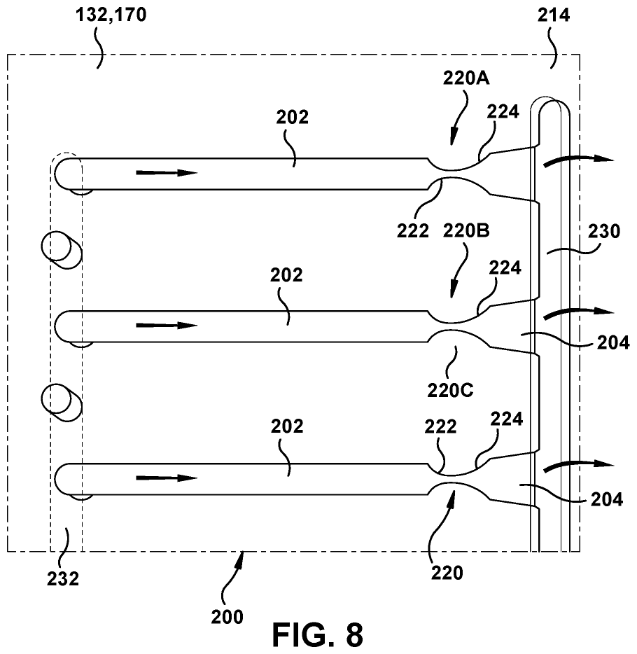

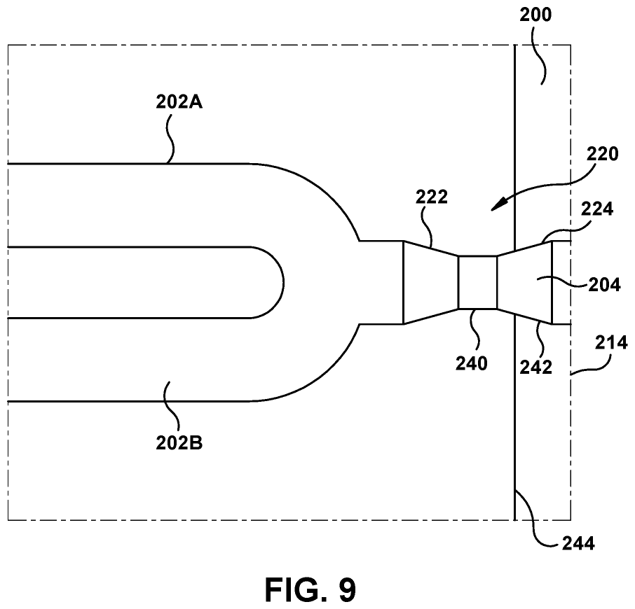

Referring to FIGS. 8 and 9, alternative arrangements of passage(s) 202 and/or exit area 204 as they relate to metering structure 220 are illustrated. In FIG. 8, exit area 204 includes a trench 230 in exterior surface 214 of body 200 in fluid communication with diverging passage portion 224. In this fashion, coolant exiting exit area 204 is fed into trench 230, which may then direct coolant in any desired manner. Also, in the FIG. 8 example, a plurality of passages 202 are provided, each with their own respective metering structure 220 at their respective exit area 204. Here, passages 202 (top, middle and bottom in example shown) may each be in fluid communication with a common plenum 232, which is, via passages 202, in fluid communication with metering structures 220. In this fashion, a number of metering structures 220A, 220B and/or 220C (e.g., a first metering structure 220A, second metering structure 220B, and third metering structure 220C) may be fluidly communicating with plenum 232. It is understood that any number of passages 202 may feed to trench 230 or exterior surface 214, e.g., one or more. Further, any number of metering structures 220 can be provided. It is noted, however, that some passages 202 may not include a metering structure. In FIG. 9, a first passage 202A and a second passage 202B merge upstream of metering structure 220. Although a variety of passages 202, metering structure 220 and exit area 204 arrangements have been illustrated in FIGS. 5-9, it is emphasized that the teachings of the disclosure may be employed with any passage 202 and exit area 204. Further, the teachings of the disclosure, while described relative to particular parts, may be employed with any hot gas path component, and further may be employed with practically any industrial machine using coolant passages.

HGP component 132, 170 (FIGS. 3-8) may be formed in a number of ways. In one embodiment, the HGP component may be formed using any now known or later developed technique including but not limited to casting, additive manufacturing (described in greater detail herein), etc. In terms of casting, the HGP component may be formed with any form of passage(s) 202 (e.g., singular, multiple, with plenum, without, plenum, etc.) and metering structure 220 may be provided in a structure or layer added to the rest of the HGP component. For example, metering structure 220 could be provided as part of a cover or a PSP layer provided over a cast part. In this case, the cast part may include the passage and the additional layer may be machined to include the metering structure. In another embodiment, as shown in phantom in FIG. 9, a first portion 240 of metering structure 220 may made of metal, e.g., any metal or metal alloy, and a second portion 242 of metering structure 220 may be made of another material such as a thermal barrier coating (TBC) material 242. For example, first portion 240 may be made using any technique described herein, e.g., casting or additive manufacturing, and a TBC material 242 may be formed over an exterior surface 244 and shaped to provide second portion 242 of metering structure 220, e.g., through machining.

It is noted that additive manufacturing is particularly suited for manufacturing HGP component 132, 170, and in particular, metering structure 220, because the metering structure 220 can be easily formed without any further machining, if desired. As used herein, additive manufacturing (AM) may include any process of producing an object through the successive layering of material rather than the removal of material, which is the case with conventional processes. As understood, additive manufacturing can create complex geometries, e.g., metering structure 220, without the use of any sort of tools, molds or fixtures, and with little or no waste material. For example, metering structure 220 can be easily created using AM. Instead of machining components from solid billets of plastic or metal, much of which is cut away and discarded, the only material used in additive manufacturing is what is required to shape the part. Additive manufacturing processes may include but are not limited to: 3D printing, rapid prototyping (RP), direct digital manufacturing (DDM), binder jetting, selective laser melting (SLM) and direct metal laser melting (DMLM). In the current setting, DMLM has been found advantageous.

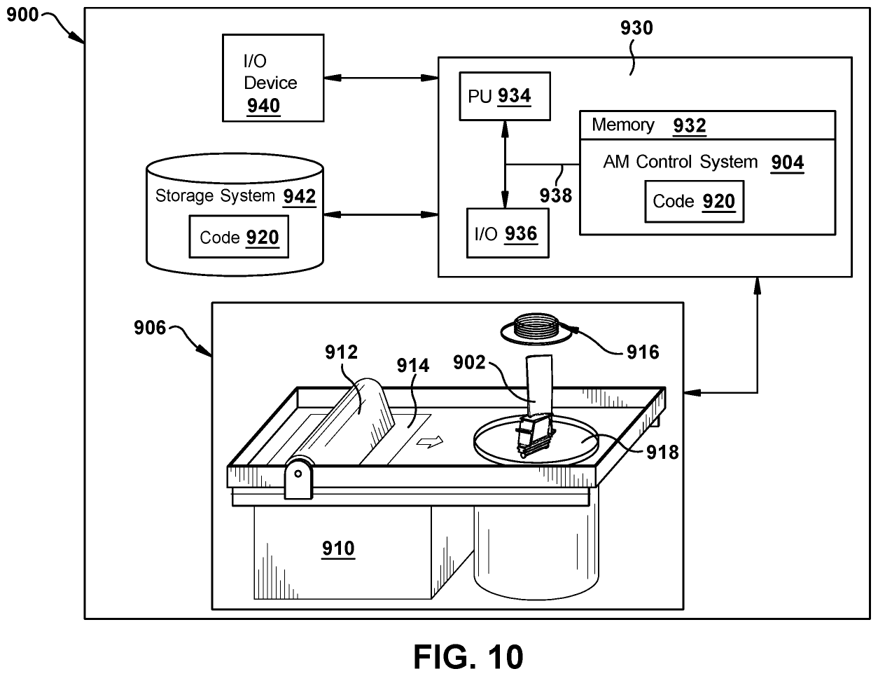

To illustrate an example of an additive manufacturing process, FIG. 10 shows a schematic/block view of an illustrative computerized additive manufacturing system 900 for generating an object 902, e.g., HGP component 132, 170 (FIGS. 3-8). In this example, system 900 is arranged for DMLM. It is understood that the general teachings of the disclosure are equally applicable to other forms of additive manufacturing. Object 902 is illustrated as all of HGP component 132, 170; however, it is understood that the additive manufacturing process can be readily adapted to manufacture parts thereof, e.g., the airfoil, shroud, etc., which may be later assembled. AM system 900 generally includes a computerized additive manufacturing (AM) control system 904 and an AM printer 906. AM system 900, as will be described, executes code 920 that includes a set of computer-executable instructions defining HGP component 132, 170 (FIGS. 3-8) to physically generate the object using AM printer 906. Each AM process may use different raw materials in the form of, for example, fine-grain powder, liquid (e.g., polymers), sheet, etc., a stock of which may be held in a chamber 910 of AM printer 906. In the instant case, HGP component 132, 170 (FIGS. 3-8) may be made of metal or metal alloys or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a polymer or where a metal binder jetting process is used. In the example shown, a laser or electron beam 916 fuses particles for each slice, as defined by code 920, but this may not be necessary where a quick setting liquid plastic/polymer is employed. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of HGP component 132, 170 (FIGS. 3-8), described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 930 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of HGP component 132, 170 (FIGS. 3-8). While the description herein discusses HGP component 132, 170 (FIGS. 3-8) as being formed with metering structure 220, it is emphasized that any part including coolant passages and desirous of including a metering structure 220 as described herein can be formed with metering structure 220, e.g., manufacture of a part of an HGP component rather than the entire HGP component, or an entirely different component than an HGP component. As noted, code 920 includes a set of computer-executable instructions defining object 902 that can be used to physically generate the object, upon execution of the code by system 900. For example, code 920 may include a precisely defined 3D model of object 902 and can be generated from any of a large variety of well known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing HGP component 132, 170 (FIGS. 3-8) into a series of thin slices that it assembles using AM printer 906 in successive layers of liquid, powder, sheet or other material. In the DMLM example, each layer is melted to the exact geometry defined by code 920 and fused to the preceding layer. In one embodiment, shown in phantom in FIG. 5, where additive manufacturing is employed to make the HGP component, metering structure 220 and/or exit area 204 may be created in a way that exit area 204 and metering structure 220 require exposing through a protective layer 234 formed to close exit area 204. Exit area 204 and metering structure 220 may be exposed using any now known or later developed technique, e.g., machining such as grinding, chemical treatment such as etching, etc. Alternatively, exit area 204 and metering structure 220 may be made in a finished or near-finished form using the AM process. In any event, the AM process provides for formation of metering structure 220, passage(s) 202, etc., in a microchannel dimensions and in body locations not previously available using other manufacturing techniques. In any event, subsequently, the HGP component 132, 170 (FIGS. 3-8) may be exposed to any variety of additional finishing processes, e.g., minor machining, sealing, polishing, assembly to another part, etc.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A hot gas path component, comprising:
a body;
a plurality of passages for delivering a coolant, the plurality of passages extending through at least a part of the body to an exit area of the body, wherein an end of each passage includes a loop; and
a metering structure in fluid communication with the passage and disposed upstream of the exit area, the metering structure including a converging passage portion followed by a diverging passage portion.

2. The hot gas path component of claim 1, wherein the exit area is in fluid communication with an exterior surface of the body.

3. The hot gas path component of claim 1, wherein each passage extends in a parallel and opposite direction to an adjacent passage.

4. The hot gas path component of claim 3, wherein a loop of each passage abuts the adjacent passage upstream of the converging passage portion of the adjacent passage.

5. The hot gas path component of claim 1, wherein the converging passage portion has a frusto-conical shape, and the diverging passage portion has a frusto-conical shape.

6. The hot gas path component of claim 1, further comprising a constant diameter passage portion fluidly coupling the converging passage portion with the diverging passage portion.

7. The hot gas path component of claim 1, wherein the plurality of passages are microchannels having a cross-sectional dimension of no greater than approximately 3.0 millimeters.

8. A non-transitory computer readable storage medium storing code representative of at least a portion of a hot gas path component, the at least a portion of the hot gas path component physically generated upon execution of the code by a computerized additive manufacturing system, the code comprising:
code representing the at least a portion of the hot gas path component, the at least a portion of the hot gas path component including:
a body;
a plurality of passages for delivering a coolant, the plurality of passages extending through at least a part of the body to an exit area of the body, wherein an end of each passage includes a loop; and
a metering structure in fluid communication with the passage and disposed upstream of the exit area, the metering structure including a converging passage portion followed by a diverging passage portion.

9. The non-transitory computer readable storage medium of claim 8, wherein the exit area is in fluid communication with an exterior surface of the body.

10. The non-transitory computer readable storage medium of claim 8, wherein each passage extends in a parallel and opposite direction to a adjacent passage.

11. The non-transitory computer readable storage medium of claim 10, wherein a loop of each passage abuts the adjacent passage upstream of the converging passage portion of the adjacent passage.

12. The non-transitory computer readable storage medium of claim 8, wherein the converging passage portion has a frusto-conical shape, and the diverging passage portion has a frusto-conical shape.

13. The non-transitory computer readable storage medium of claim 8, further comprising a constant diameter passage portion fluidly coupling the converging passage portion with the diverging passage portion.

14. The non-transitory computer readable storage medium of claim 8, wherein the plurality of passages are microchannels having a cross-sectional dimension of no greater than approximately 3.0 millimeters.

15. A gas turbine system, comprising:
a compressor;
a combustor operatively coupled to the compressor; and
a turbine receiving a hot gas flow from the combustor, the turbine including at least one hot gas path component including:
a body;
a plurality of passages for delivering a coolant, the plurality of passages extending through at least a part of the body to an exit area of the body, wherein an end of each passage includes a loop; and
a metering structure in fluid communication with the passage and disposed upstream of the exit area, the metering structure including a converging passage portion followed by a diverging passage portion.

16. The gas turbine of claim 15, wherein the exit area is in fluid communication with an exterior surface of the body.

17. The gas turbine of claim 15, wherein each passage extends in a parallel and opposite direction to an adjacent passage.

18. The hot gas path component of claim 17, wherein a loop of each passage abuts the adjacent passage upstream of the converging passage portion of the adjacent passage.

19. The gas turbine of claim 15, wherein the converging passage portion has a frusto-conical shape, and the diverging passage portion has a frusto-conical shape.

20. The gas turbine of claim 15, further comprising a constant diameter passage portion fluidly coupling the converging passage portion with the diverging passage portion.
